(19) United States
(12) Patent Application Publication
(10) Pub. No.: US 2025/0001438 A1
(43) Pub. Date: Jan. 2, 2025

(54) FLOCKING PROCESSING DEVICE

(71) Applicant: Seo Yeong Pile Tech. Co., Ltd., Ulsan (KR)

(72) Inventor: Sang Ho KIM, Asan-si (KR)

(21) Appl. No.: 18/667,948

(22) Filed: May 17, 2024

(30) Foreign Application Priority Data
Jun. 30, 2023 (KR) 10-2023-0084643

(51) Int. Cl. B05B 7/14; B05B 14/10; B05B 15/40; B05B 15/52

(52) U.S. Cl. CPC B05B 7/1409; B05B 14/10; B05B 15/40; B05B 15/52

(57) ABSTRACT

Provided is a flocking processing device which includes: a processing unit, and injector is installed around the processing object to inject the fibers; a dust collection unit having an inlet; a supply unit; a separation unit scattering the fibers while passing through the filter installed on an outer surface of a separation tank; and a distribution unit in which distribution members is installed below partitioned distribution pipes in the lower portion of the collection tank. Air is input into the respective distribution members to evenly supply the fibers to the injectors.

### BACKGROUND OF THE INVENTION

### 1. Field of the Invention

The present invention relates to a flocking processing device, and more particularly, to a flocking processing device that evenly supplies and injects fibers to a plurality of injection means during a task of injecting and coating the fibers onto a rotor, and separates fibers which remain after use not to be clumped, and then resupplies the fibers to a processing unit again.

### 2. Description of the Related Art

In general, in flocking, a fiber made of fine synthetic resin fibers is planted on the surface of a sticking agent and the surface of the sticking agent is completely coated to change a texture according to physical properties of the planted fibers.

The fibers used for such a flocking task adopt rayon, nylon, polyester, and polyaramid having a diameter of 1 mm to 1.5 mm and a length of 0.1 to 0.5 mm, and processing devices using mechanical vibration or high-voltage static electricity are used for coating the surface of the sticking agent of the supplied fibers.

Such a flocking processing device in related art is disclosed in Korean Utility Model 20-0171983, Korean Patent Registration No. 10-0282735, and Korean Patent Registration No. 10-0321123.

However, in the flocking processing device in the related art which is prior applied, there is a problem in that fibers are fed only with a simple screw device, and supplied to a supply pipe of the processing device by using a blower, so it is difficult to supply a predetermined amount of fibers.

In other words, since the fibers are subjected to processing with electric charging processing while high-voltage electricity is applied in order to increase a flocking effect, a flocking quality becomes poor when the fibers are reused due to a property in which the fibers are easily clumped, and the clumped fibers block the supply pipe of the processing device or are caught in the blower.

Further, foreign materials are removed in order to reuse the fiber, and it is necessary to go through separate selection processes such as humidification, separation, and selection for removing humidification, static electricity, and stress, so the task is cumbersome.

### RELATED ART DOCUMENT

### Patent Document

(Patent Document 1) Korean Patent Registration No. 10-0282735 (Nov. 30, 2000)
(Patent Document 2) Korean Patent Registration No. 10-0321123 (Jan. 4, 2002)
(Patent Document 1) Korean Utility Model No. 20-0171983 (Dec. 8, 1999)

### SUMMARY OF THE INVENTION

An object of the present invention is to evenly supply and inject fibers to a plurality of injection means during a task of injecting and coating the fibers onto a processing object, and separate fibers which remain after use not to be clumped, and then resupply the fibers to a processing unit again.

Further, another object of the present invention is to easily remove foreign materials which are mixed in fibers, and easily clean the fibers to reuse the fibers which remain after use.

Moreover, yet another object of the present invention is to finely adjust a fiber supply amount.

According to an aspect of the present invention, a flocking processing device, which separates fibers which remain after use not to be clumped during a task of coating the fibers onto the surface of a processing object, and then resupplies the fibers, includes: a processing unit in which a jig holding the processing object is stored, and a plurality of injection means is installed around the processing object to inject the fibers to the processing object; a dust collection unit having an inlet into which the fibers which remain after use in the processing unit are introduced, which is installed on one side, and including a dust collection tank of which lower portion is opened; a supply unit configured by a supply means in which a discharge means installed in a lower portion of the dust collection unit and rotated by a first motor makes the fibers discharged from the dust collection unit be introduced into a supply tank, and an agitation means which is rotatable is installed inside the supply tank to separate the fibers input into the supply tank and input the separated fibers with lead-movement of a supply member which rotates by a second motor; a separation unit in which a separation means which scatters the fibers while passing through the filter installed on an outer surface of a separation tank accommodating the fibers input through the supply unit and rotated by a third motor is accommodated in the collection tank; and a distribution unit in which a plurality of distribution members is installed below a plurality of partitioned distribution pipes in the lower portion of the collection tank, and air is input into the respective distribution members to evenly supply the fibers to a plurality of injection means.

According to the present invention, in the distribution unit, a plurality of partitioned inlet holes is formed in the lower portion of the collection tank, and a distribution pipe in which a plurality of input holes is penetrated is installed, a brush shaft with a plurality of brushes, which is formed in the distribution pipe rotates to evenly supply the fibers into the input holes, and a plurality of distribution members is installed in the lower portion of the distribution pipe to be spaced apart from each other, and air is input into an injection pipe installed on a side surface of the distribution member to be in communication with the side surface of the distribution member.

According to the present invention, in the separation means, one or more filters are installed on an outer surface of a separation tank which rotates around a rotary shaft which rotates by receiving a rotary force of a third motor.

According to the present invention, a pivotable perspective window is installed in the separation tank.

According to the present invention, the separation tank having a cylindrical or polygonal pillar shape has one or more discharge holes on an outer circumference thereof.

According to the present invention, the flocking processing device further includes one or more wing plates installed on an inner peripheral surface of the separation tank.

As described above, according to an exemplary embodiment of the present invention, a flocking processing device, which evenly supplies and injects fibers to a plurality of injection means and separates fibers which remain after use not to be clumped during a task of coating the fibers onto the surface of a processing object, and then resupplies the fibers, includes: a processing unit in which a jig holding the processing object is stored, and a plurality of injection means is installed around the processing object to inject the fibers to the processing object; a dust collection unit having an inlet into which the fibers which remain after use in the processing unit are introduced, which is installed on one side, and including a dust collection tank of which lower portion is opened; a supply unit configured by a supply means in which a discharge means installed in a lower portion of the dust collection unit and rotated by a first motor makes the fibers discharged from the dust collection unit be introduced into a supply tank, and an agitation means which is rotatable is installed inside the supply tank to separate the fibers input into the supply tank and input the separated fibers with lead-movement of a supply member which rotates by a second motor; a separation unit in which a separation means which scatters the fibers while passing through the filter installed on an outer surface of a separation tank accommodating the fibers input through the supply unit and rotated by a third motor is accommodated in the collection tank; and a distribution unit in which a plurality of distribution members is installed below a plurality of partitioned distribution pipes in the lower portion of the collection tank, and air is input into the respective distribution members to evenly supply the fibers to the plurality of injection means, so even thin fibers are resupplied not to be clumped, thereby increasing task efficiency and a completion level of the processing object.

Further, in the flocking processing device of the present invention, so as to easily remove foreign materials which are mixed in fibers, and easily clean the fibers to reuse the fibers which remain after use, a pivotable perspective window is installed in the separation tank, so maintenance is enhanced.

Moreover, in the flocking processing device of the present invention, one or more filters are installed on the outer surface of the separation tank which rotates around the rotary shaft which rotates by receiving the rotary force of the third motor so as to finely adjust the fiber supply amount to reduce the blockage of the supply pipe and minimize a disconnection phenomenon of the fibers.

### BRIEF DESCRIPTION OF THE DRAWINGS

FIG. 1 is a front view illustrating a flocking processing device according to the present invention.

FIG. 2 is a side view illustrating the flocking processing device according to the present invention.

FIG. 3 is a side cross-sectional view illustrating the flocking processing device according to the present invention.

FIG. 4 is a perspective view illustrating an exemplary embodiment of the flocking processing device according to the present invention.

FIGS. 5 to 7 are cross-sectional views illustrating various other exemplary embodiments of the flocking processing device according to the present invention.

FIG. 8 is a side view illustrating various exemplary embodiments of a separation tank shape of the flocking processing device according to the present invention.

FIG. 9 is a side view illustrating still another exemplary embodiment of the flocking processing device according to the present invention.

FIG. 10 is a front cross-sectional view illustrating a distribution unit of the flocking processing device according to the present invention.

FIG. 11 is a side cross-sectional view illustrating the distribution unit of the flocking processing device according to the present invention.

FIG. 12 is a plan view illustrating a processing unit of the flocking processing device according to the present invention.

FIG. 13 is a front view illustrating the processing unit of the flocking processing device according to the present invention.

### DETAILED DESCRIPTION OF THE PREFERRED EMBODIMENT

Hereinafter, the present invention will be described in detail with reference to the accompanying drawings in the present invention. First, among drawings, it should be noted that the same constituent elements or components are represented by the same reference numerals. In describing the present invention, a detailed description of known functions and configurations incorporated will be omitted so as to avoid obscuring the gist of the present invention.

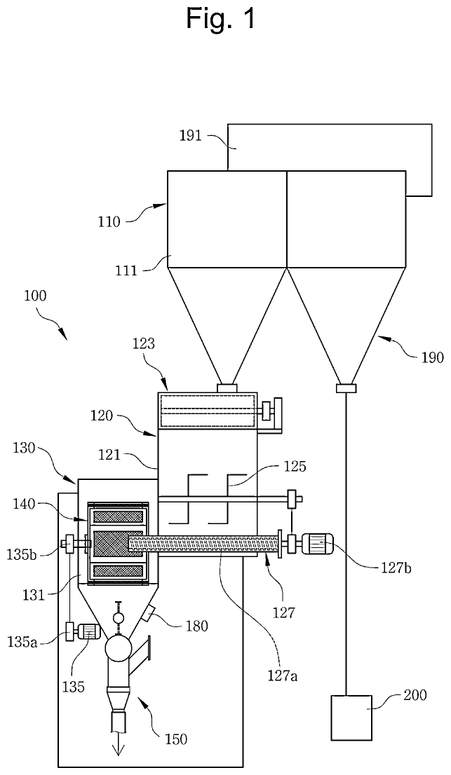

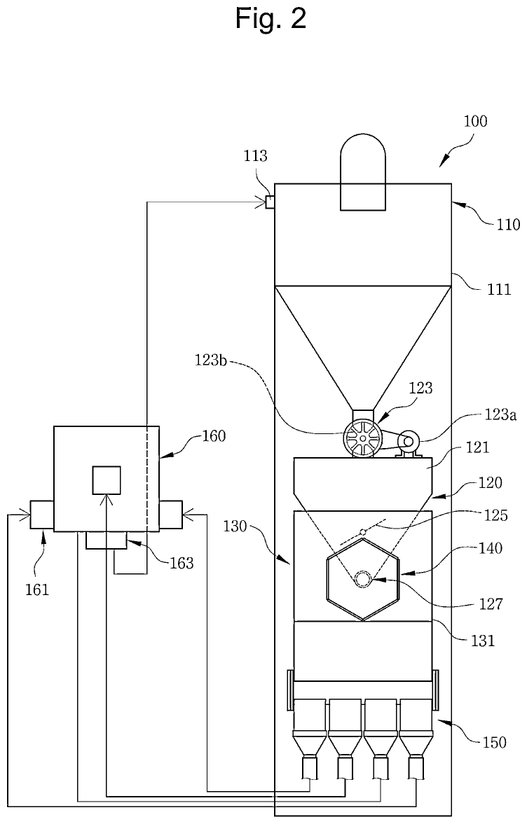

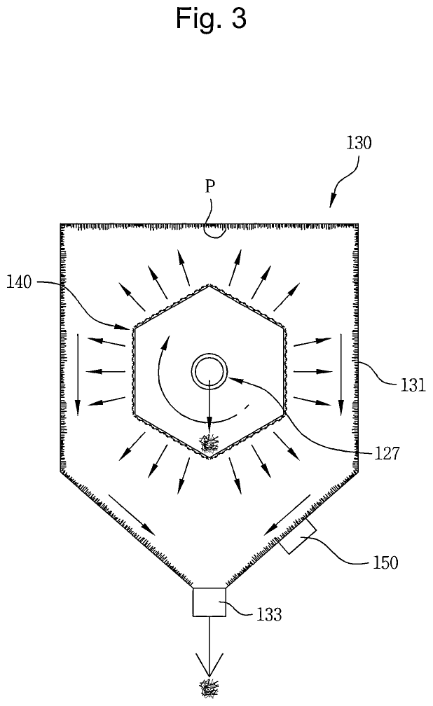

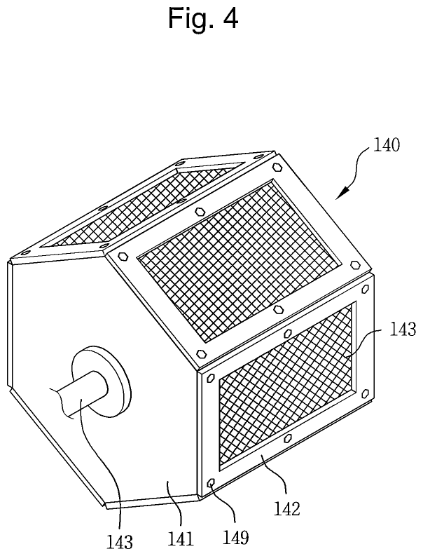

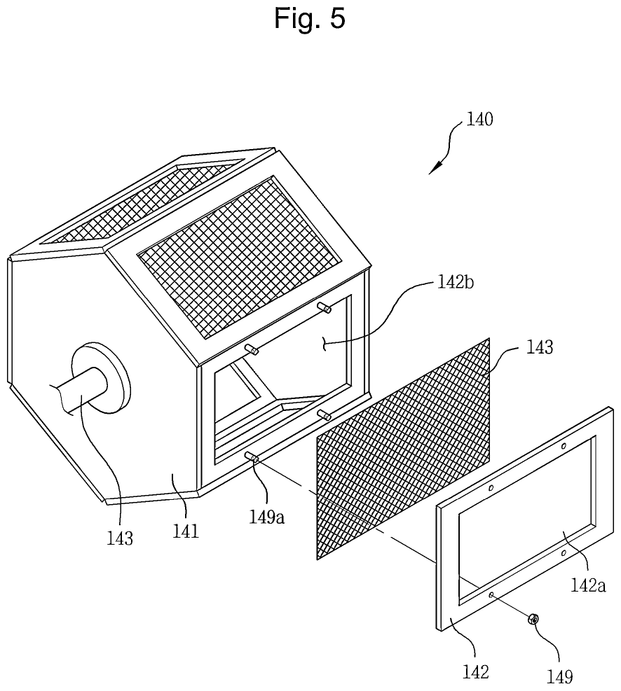

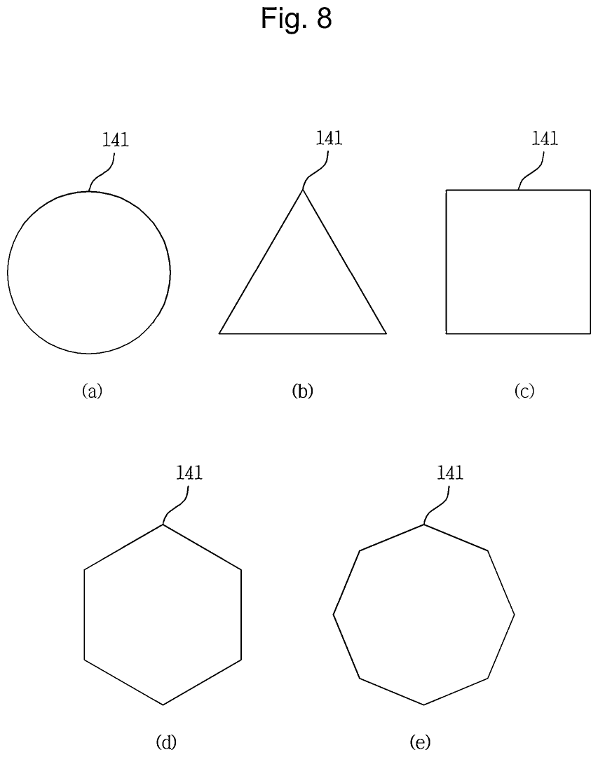

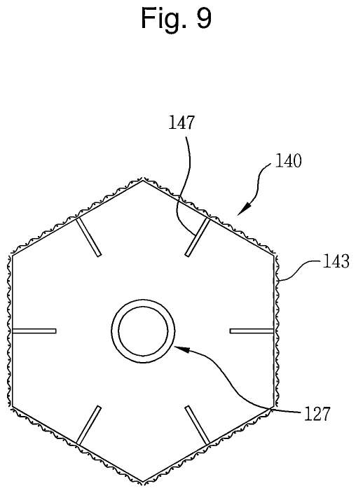

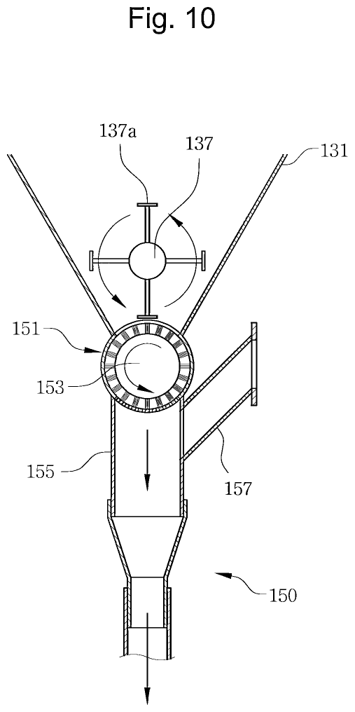

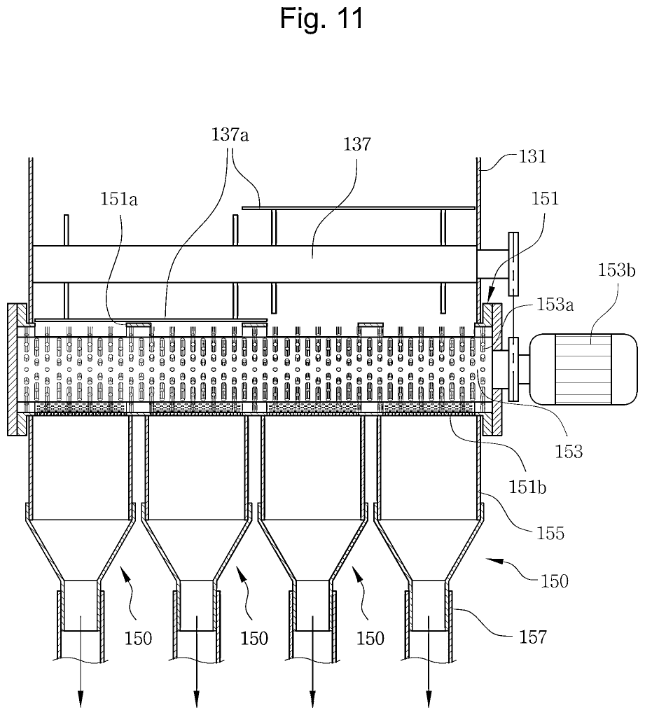

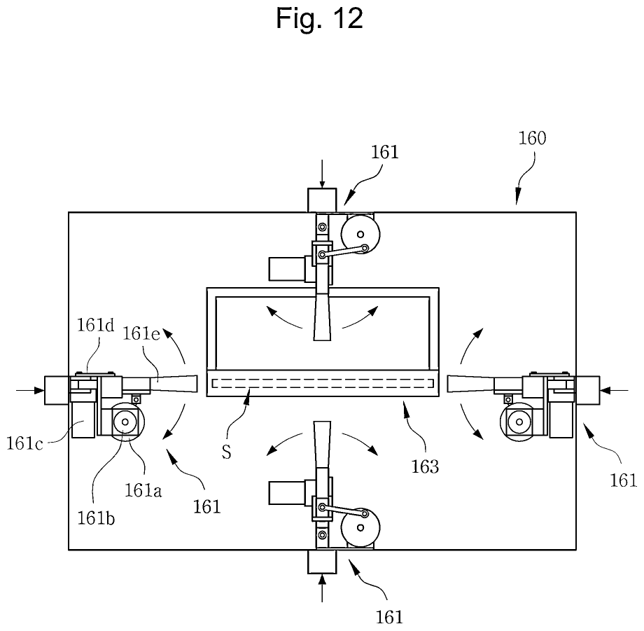

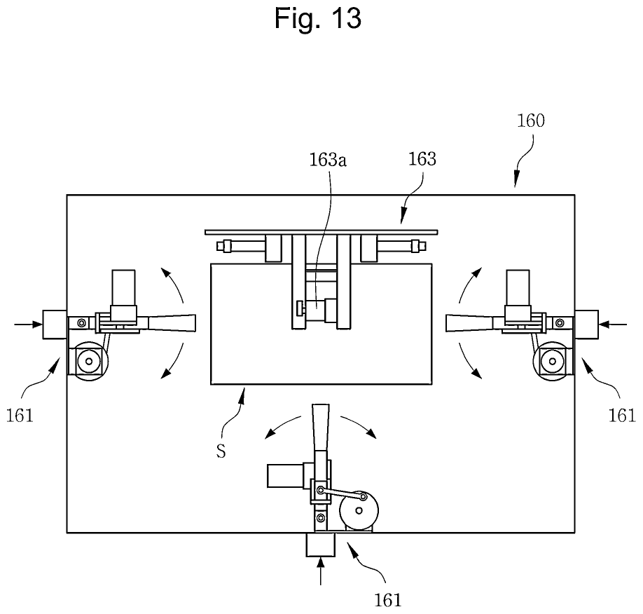

FIG. 1 is a front view illustrating a flocking processing device according to the present invention, FIG. 2 is a side view illustrating the flocking processing device according to the present invention, FIG. 3 is a side cross-sectional view illustrating the flocking processing device according to the present invention, FIG. 4 is a perspective view illustrating an exemplary embodiment of the flocking processing device according to the present invention, FIGS. 5 to 7 are cross-sectional views illustrating various other exemplary embodiments of the flocking processing device according to the present invention, FIG. 8 is a side view illustrating various exemplary embodiments of a separation tank shape of the flocking processing device according to the present invention, FIG. 9 is a side view illustrating still another exemplary embodiment of the flocking processing device according to the present invention, FIG. 10 is a front cross-sectional view illustrating a distribution unit of the flocking processing device according to the present invention, FIG. 11 is a side cross-sectional view illustrating the distribution unit of the flocking processing device according to the present invention, FIG. 12 is a plan view illustrating a processing unit of the flocking processing device according to the present invention, and FIG. 13 is a front view illustrating the processing unit of the flocking processing device according to the present invention.

First, as illustrated in FIGS. 1 and 2, when a configuration state of the flocking processing device 100 according to the present invention is described, the flocking processing device 100 installs a processing object in a processing unit 160, and then plants fibers F made of a fine synthetic resin fiber injected by an injection means 161, and completely coats the surface of a sticking agent to change a texture according to physical properties of the planted fiber.

At this time, during a task of coating the fibers F injected through the injection means 161 onto the processing object accommodated in the processing unit 160, fibers F which remain after use are separated not to be clumped, and then resupplied to the processing unit 160.

The flocking processing device 100 according to the present invention will be described in more detail as follows.

First, the flocking processing device 100 is constituted by a dust collection unit 110, a supply unit 120, a separation unit 130, a distribution unit 140, and a processing unit 160.

Here, the fibers F which remain after use by the processing unit 160 are discharged from the dust collection unit 110 through a discharge means 163. At this time, an inlet 113 which is connected by a connection line and into which the discharged fibers F are introduced is installed at one side and includes a dust collection tank 111 of which a lower portion is opened.

As the dust collection tank 111, a hopper having a venturi shape in which an upper portion is wide and a lower portion is narrowed to discharge the fibers F in a high dust collection efficiency state only with a gravity by a self-load is preferable, but the dust collection tank 111 is not limited thereto.

Moreover, the dust collection tank 111 is capable of additionally supplementing and supplying the fibers F.

Further, the supply unit 120 is installed in a lower portion of the dust collection unit 110 to be in communication with the dust collection unit 110. In particular, in the supply unit 120, the discharge means 123 is installed in the lower portion of the dust collection tank 111. Upper and lower portions of the discharge means 123 are opened, and a rotor 123b installed in the discharge means 123 is rotated by a first motor 123a to allow the fibers F discharged from the dust collection unit 110 to be quantitatively introduced into the supply tank 121.

The discharge means 123 also discharges high-pressure air which is filled in the dust collection tank 111 to a lower portion through which the fiber F is discharged to prevent an internal pressure of the dust collection tank 111 from being increased, thereby reducing fibers F which are scattered.

Furthermore, it is preferable that the rotor 123b is manufactured by a rubber resin in order to prevent cutting or damage of the fibers F supplied upon rotation, and generation of static electricity.

Moreover, a rotatable agitation means 125 is installed inside the supply tank 121 to separate the fibers F input into the supply tank 121. The agitation means 125 has a plurality of bars which is bent in a “¬” shape, and then are installed in corresponding directions to make the fibers F be separated better.

Further, the agitation means 125 may rotate by receiving a rotary force of a second motor 127b.

As the supply tank 121, the hopper having the venturi shape in which an upper portion is wide and a lower portion is narrowed to discharge the fibers F in a high dust collection efficiency state only with the gravity by the self-load is preferable, but the supply tank 121 is not limited thereto.

Moreover, a supply means 127 is installed in a lower portion of the supply tank 121, which moves the fibers F. Here, the supply means 127 inputs the fibers F primarily separated through the agitation means 125 with lead-movement of a supply member 127a rotated by the second motor 127b.

In addition, the supply member 127a adopts a spring feeder which lead-moves by receiving the rotation of the second motor 127b, but is not limited thereto. That is, while a feed spring is rotated forward or backward by the second motor 127b, the fibers F are adjusted to be discharged to the outside so as to be quantitatively discharged for reuse or discarded. The feed spring as a coil type generally adopts a feed spring which is enabled to be purchased.

In addition, the separation unit 130 is configured by the separation means 140 accommodated in the collection tank 131.

First, as the collection tank 131, the hopper having the venturi shape in which an upper portion is wide and a lower portion is narrowed to discharge the fibers F in a high dust collection efficiency state only with the gravity by the self-load is preferable, but the collection tank 131 is not limited thereto.

Furthermore, the separation means 140 accommodates the fibers F input through the supply unit 120, and scatters the fibers F while passing through a filter 143 installed on an outer surface of the separation tank 141 rotated by a third motor 135.

Here, the filter 143 preferably has a mesh form in which a vertical line and a transverse line mutually cross perpendicularly to each other in a mesh form, but is not limited thereto.

In particular, the filter 143 is an optimal form having 23 to 33 strands for 1 inch. At this time, a line diameter of one strand is preferably 0.21 mm to 0.25 mm, and a separation space is preferably 0.4 mm to 0.9 mm. That is, 23 to 25 strands for 1 inch are optimal to 3D fibers F, and 31 to 33 strands for 1 inch are optimal to 1.5D fibers F. Further, it is preferable that a material of the filter 143 is stainless.

Among the filters 143, when the filter 143 is selectively applied according to the type of fiber F, the filter 143 quantitatively supplies the fibers F while filtering the foreign material.

At this time, a driving pulley 135a is installed in the third motor 135 and a driven pulley 135b receiving a rotary force of the driving pulley 135a is installed in the separation means 140 to rotate the separation means 140.

The discharged fibers F are resupplied to the injection means 161 through the distribution unit 150 installed in the lower portion of the collection tank 131.

In particular, as illustrated in FIGS. 3 to 5, in the separation unit 140, one or more filters 143 are installed on the outer surface of the separation tank 141 which rotates around a rotary shaft 143 which rotates by receiving the rotary force of the third motor 135.

Consequently, in the flocking processing device 100 according to the present invention, one or more filters 143 are installed on the outer surface of the separation tank 141 which rotates around the rotary shaft 143 which rotates by receiving the rotary force of the third motor 135 so as to finely adjust the fiber supply amount to reduce the blockage of the supply pipe and minimize a disconnection phenomenon of the fibers F.

Moreover, one or more separation spaces 142b are opened, the separation spaces 142b are covered with the filter 143, and a coupling plate 142 in which a discharge hole 142a is opened is installed on the outer peripheral surface of the separation tank 141.

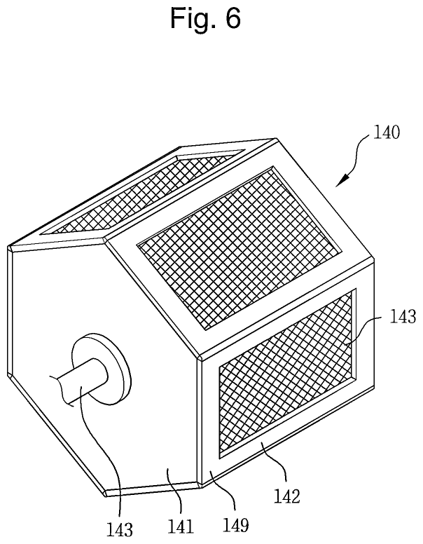

At this time, a fastening 149 is installed at a protrusion 149a installed in the separation tank by screw fastening in the coupling plate 142. However, as illustrated in FIG. 6, it is possible to install the coupling plate 142 through welding in addition to the screw fastening.

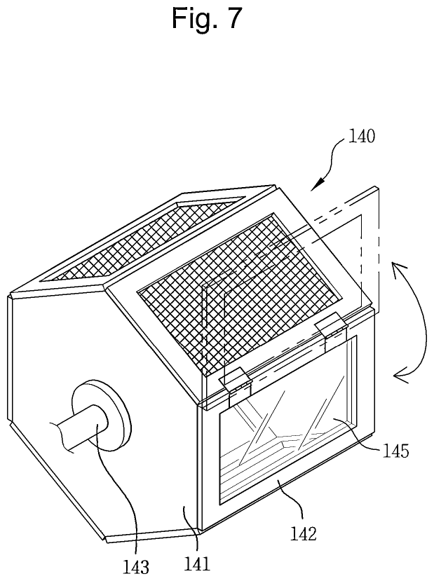

Meanwhile, as illustrated in FIG. 7, a perspective window 145 which is pivotable is installed on one side of an outer peripheral surface of the separation tank 141.

Further, as illustrated in FIG. 8, the separation tank 141 has a cylindrical or polygonal pillar (3, 4, 6, or 8 angled) shape, and one or more discharge holes 142a are formed on an outer circumference.

Consequently, in the flocking processing device 100 according to the present invention, the perspective window 145 which is pivotable is installed in the separation tank 141 so as to easily remove the foreign material mixed in the fibers F and easily clean the fibers F to reuse the fibers F which remain after use, so maintenance is enhanced.

Moreover, the flocking processing device 100 includes a vibration member 180 installed on one side of the outer peripheral surface of the collection tank 131. The vibration member 180 supplies vibration to the collection tank 131 to drop the scattered fibers F to an internal surface of the collection tank 131. In particular, the vibration member 180 preferably adopts a vibrator, but is not limited thereto.

Meanwhile, as illustrated in FIG. 9, the flocking processing device 100 includes one or more wing plates 147 installed on an inner peripheral surface of the separation tank 141. The fibers F are organized through the wing plate 147 to guide the fibers F to easily pass through the filter 143.

Moreover, in the dust collection unit 110, a connection tank 191 which is in communication with a recovery unit 190 is installed above the dust collection unit 110 and the recovery unit 190. The scattered fibers F are collected by the dust collection unit 110 through the connection tank 191 and collected by the recovery tank 200.

Further, as illustrated in FIGS. 10 and 11, the distribution unit 150 is installed in the lower portion of the collection tank 131.

At this time, in the distribution unit 150, a plurality of partitioned inlet holes 151a is formed in the lower portion of the collection tank 131, and a distribution pipe 151 in which a plurality of input holes 151b is penetrated is installed in the distribution unit 150.

Furthermore, a brush shaft 153 with a plurality of brushes 153a is inserted into the distribution pipe 151. The brush shaft 153 rotates with an outer portion receiving a rotary force of a fourth motor 153b.

Moreover, a crushing shaft 137 is installed in the collection tank 131 at an upper side of the distribution pipe 151, and a crushing plate 137a is installed to be spaced apart from an outer circumference of the crushing shaft 137. In the crushing plate 137a, a plurality of rectangular bars is installed in a cross direction to make the fibers F be crushed better.

Moreover, the crushing shaft 137 rotates by receiving the rotary force of the fourth motor 153b through a belt.

That is, the fibers F filled in the collection tank 131 are evenly stacked while the crushing plate 137a rotates to guide the fibers F to be evenly input into the inlet hole 151a. Furthermore, the brush shaft 153 rotates to evenly supply the fibers F to the input hole 151b.

In addition, a plurality of distribution members 155 is installed in the lower portion of the distribution pipe 151 to be spaced apart from each other, and air is input into an injection pipe 157 installed on a side surface of the distribution member 155 to be in communication with the side surface of the distribution member 155 to discharge the fibers F to a discharge pipe 157 connected to the lower portion of the distribution member 155.

Meanwhile, as illustrated in FIGS. 12 and 13, a jig 163 holding a processing object S is stored in the processing unit 160, and a plurality of injection means 161 is installed around the processing object S to inject the fibers F to the processing object S. The fibers F fed through the discharge pipe 157 are supplied to the respective injection means 161.

Here, the injection means 161 is constituted by a first cam 161a and a first control motor 161b which repeatedly pivot a nozzle 161e vertically and a second cam 161c and a second control motor 161d which repeatedly pivot the nozzle 161e horizontally.

At this time, the first cam 161a and the second cam 161c are connected to a link shaft (not illustrated) to repeatedly pivot the nozzle 161e horizontally and vertically.

Moreover, the flocking processing device 100 includes a vibration member 163a installed in the jig 163. The vibration member 163a supplies vibration to the processing object S to evenly coat the fibers F onto the surface of the processing object S. In particular, the vibration member 163a preferably adopts the vibrator, but is not limited thereto.

Consequently, a flocking processing device 100 according to an exemplary embodiment of the present invention which separates fibers F which remain after use not to be clumped during a task of coating the fibers F onto the surface of a processing object S, and then resupplies the fibers so as to evenly supply and inject fibers F to a plurality of injection means 161 during a task of coating the fibers F onto the surface of a processing object S, and separate fibers F which remain after use not to be clumped, and then resupply the fibers to a processing unit 160 again, includes a processing unit 160 in which a jig 163 holding the processing object S is stored, and a plurality of injection means 161 is installed around of the processing object S to inject the fibers F to the processing object S, a dust collection unit 110 having an inlet 113 into which the fibers F which remain after use in the processing unit 10 are introduced, which is installed on one side, and including a dust collection tank 111 of which lower portion is opened, a supply unit 120 configured by a supply means 127 in which a discharge means 123 installed in a lower portion of the dust collection unit 110 and rotated by a first motor 123a makes the fibers F discharged from the dust collection unit 110 be introduced into a supply tank 121, and an agitation means 125 which is rotatable is installed inside the supply tank 121 to separate the fibers F input into the supply tank 121 and input the separated fibers F with lead-movement of a supply member 127a which rotates by a second motor 127b, a separation unit 130 in which a separation means 140 which scatters the fibers F while passing through the filter 143 installed on an outer surface of a separation tank 141 accommodating the fibers F input through the supply unit 120 and rotated by a third motor 135 is accommodated in the collection tank 131, and a distribution unit 150 in which a plurality of distribution members 155 is installed below a plurality of partitioned distribution pipes 151 in the lower portion of the collection tank 131, and air is input into the respective distribution members 155 to evenly supply the fibers F to the plurality of injection means 161, so even thin fibers F are resupplied not to be clumped, thereby increasing task efficiency and a completion level of the processing object.

The terms “about”, “substantially”, and the like used herein are used as a numerical value or a value close to the numerical value when inherent manufacturing and material tolerances are presented in the stated meaning, and used to prevent an unscrupulous infringer from unfairly using disclosed contents in which precise or absolute numerical values are mentioned to help in the understanding of the present invention.

As described above, the present invention is not limited to the aforementioned embodiments and the accompanying drawings, and it will be obvious to those skilled in the technical field to which the present invention pertains that various substitutions, modifications, and changes may be made within the scope without departing from the technical spirit of the present invention.

What is claimed is:

1. A flocking processing device which separates fibers which remain after use so as not to be clumped during a task of coating the fibers onto a surface of a processing object, and then resupplies the fibers, comprising:
a processing unit in which a jig holding the processing object is stored, and a plurality of injection means is installed around the processing object to inject the fibers to the processing object;
a dust collection unit having an inlet into which the fibers which remain after use in the processing unit are introduced, which is installed on one side, and including a dust collection tank of which a lower portion is opened;
a supply unit configured by a supply means in which a discharge means installed in a lower portion of the dust collection unit and rotated by a first motor makes the fibers discharged from the dust collection unit be introduced into a supply tank, and an agitation means which is rotatable is installed inside the supply tank to separate the fibers input into the supply tank and input the separated fibers with lead-movement of a supply member which rotates by a second motor;
a separation unit in which a separation means which scatters the fibers while passing through a filter installed on an outer surface of a separation tank accommodating the fibers input through the supply unit and rotated by a third motor is accommodated in the collection tank; and
a distribution unit in which a plurality of distribution members is installed below a plurality of partitioned distribution pipes in the lower portion of the collection tank, and air is input into the respective distribution members to evenly supply the fibers to the plurality of injection means.

2. The flocking processing device of claim 1, wherein in the distribution unit, a plurality of partitioned inlet holes is formed in the lower portion of the collection tank, and a distribution pipe in which a plurality of input holes is penetrated is installed in the distribution unit, a brush shaft with a plurality of brushes, which is formed in the distribution pipe rotates to evenly supply the fibers into the input holes, and a plurality of distribution members is installed in a lower portion of the distribution pipe to be spaced apart from each other, and air is input into an injection pipe installed on a side surface of the distribution member to be in communication with the side surface of the distribution member.

3. The flocking processing device of claim 1, wherein in the separation means, the one or more filters are installed on the outer surface of the separation tank which rotates around a rotary shaft which rotates by receiving a rotary force of the third motor.

4. The flocking processing device of claim 3, wherein a pivotable perspective window is installed in the separation tank.

5. The flocking processing device of claim 3, wherein the separation tank having a cylindrical or polygonal pillar shape has one or more discharge holes on an outer circumference thereof.

6. The flocking processing device of claim 3, further comprising:
one or more wing plates installed on an inner peripheral surface of the separation tank.
